(19) United States
(12) Patent Application Publication
(10) Pub. No.: US 2003/0226118 A1
(43) Pub. Date: Dec. 4, 2003

(54) Method of uploading and editing words at a network station

(75) Inventor: Chun-Yen Lee, Chung Ho City (TW)

Correspondence Address: BACON & THOMAS, PLLC, 625 SLATERS LANE, FOURTH FLOOR, ALEXANDRIA, VA, 22314

(73) Assignee: E C D Interactive Corp., Taipei (TW)

(21) Appl. No.: 10/155,066

(22) Filed: May 28, 2002

(51) Int. Cl. G06F 17/24

(52) U.S. Cl. 715/542

(57) ABSTRACT

A method of uploading and editing words at a network station, wherein a Unicode table and a font data base are provided in the server of a network mainframe terminal, and an option entry is correspondingly provided on a web page, so that when a client uploads the input Chinese (Big5) character strings and selected fonts, colors, sizes etc. of words to the server of the network mainframe terminal, the Unicode table and the font data base dismantle the input into the corresponding information of character digital codes (Unicode) and colors, sizes etc. and send to a FontFile and the ImageTTFText functions of the database for execution and outputting, a corresponding font graphic file thus is produced and downloaded to a computer at a client's terminal to edit fonts on a web page without installing the software of fonts, colors and sizes of words, thereby, the network station is further endued with the ability of word editing to increase the function of Internet.

### BACKGROUND OF THE INVENTION

1. Field of the Invention

The present invention is related to a method of uploading and editing words at a network station, and especially to such a method which can render a computer at the user's terminal to edit fonts on a web page without installing the software of fonts, colors and sizes of words, thereby, the network station can further be endued with ability of word editing to increase the function of Internet.

2. Description of the Prior Art

Internet appears to have a more complicated problem of data interchange among international countries. Take a view only of Taiwan, the problems resided in the internal Chinese codes have been long blamed; in the present days when Internet is prosperously developed, if one wants to communicate with a Japanese network station, he must know in the first place the words used are of the kind of JIS (Japanese Industrial Standard) or Shift-JIS or EUC-JP, then he shall use Japanese fonts or a multi-country language explorer tool for switching among the language systems; when he sees the network station with simplified Chinese characters, he shall switch to the editing mode of GB (Guo Biao code) . . . . Every district has its own suit or suits of internal word codes. Irrespective of whether a user of information can understand the alien words that he is not familiar with, when he is lack of a related switching tool, he can even only do nothing for the information. When in such a trouble in using Internet, in addition to prepare a multi-country language explorer tool (such as the notable Njwin, Kanj iWEB, RichWin . . . etc.), if a user uses a network resource access tool such as a browser with the function of changing the font displayed or language switching, information of other language systems can also be seen when the fonts of the other language systems have been installed and set.

Although the above stated ways can solve many problems of encoding, they are not the true ways of solution. In the world of Internet, if we can have a suit of unified words, the trouble and cumber stated above may be gotten rid of soon. Now there is Uni code, it has a certain function on the information interchange among different language systems. Unicode includes the words and symbols generally seen in the world, it is intended to be a unified internal code system to save the work of switching for information interchange.

The software environment of Unicode includes the following well-known systems:

1. Java;

2. Solaris, this UNIX operational system is provided by Sun Microsystem just like the Java programmed language;

3. Unicode used in Windows NT; the application program using Unicode can directly output and input Uni code, those programs using the known SBCS/DBCS character sets will make the system change the output and input results into character sets in the first place and then leave them to the application program;

4. The application program can use Unicode under Windows 95, however, even Unicode is used by the application program to deal with the output and input, the final output and input results still are the words of SBCS/DBCS character sets; when a program of Unicode is displayed by Unicode strings output from the textout of the system under Windows 95, what a user sees are the strings of Big 5 internal codes.

Others, such as NEXTSTEP (since NEXTSTEP 4.0, its name has been changed to OPENSTEP), MacOS, Internet Explorer and Netscape Navigator . . . have provided Unicode supports;

All around the world, only these operational environments are mentioned to have Unicode supports. Others, such as Linux which uses NLS to switch among language systems, OS/2 Warp which uses the changing of codepage to achieve the object of using other language systems, these are all alike to the environment switching actions displayed with internal codes that a Chinese system can do when the Chinese internal codes are numerous. Under the condition when these environments are unable to support Unicode, the users using these environments still need code changing tools for working.

### SUMMARY OF THE INVENTION

The network browser developed of the present invention uses word encoding of Unicode to solve the difficult dealing technique of the 2-byte language systems on the character tables. The above stated problems create individual destruction of words and 64 k space limits, the difference in supporting Unicode etc. of the operational environments of the users. The present invention is the first to make a user's computer to dynamically input the content of words to a web page for editing without installing Unicode word encoding fonts, and can simultaneously support the processing of fonts of plural language Systems of the non-English language systems including Chinese, Japanese, Korean characters.

In particular, the present invention provides a method of uploading and editing words at a network station, wherein mainly a Unicode table and a font data base are provided in the server of a network mainframe terminal, and an option entry is correspondingly provided on a web page, so that when a client uploads the input Chinese (Big5) strings and selected fonts, colors, sizes etc. to the server of the network mainframe terminal, the Unicode table and the font data base dismantle them into the corresponding information of character digital codes (Unicode) and colors, sizes etc. and send to the FontFile & ImageTTFText functions for execution and outputting, a corresponding font graphic file can thus be produced and downloaded to the client's terminal.

Therefore, the primary object of the present invention is: by the method of uploading and editing words at a network station, a computer at the user's terminal can dynamically input the edited fonts of words to a web page without installing the software of fonts, colors and sizes of words, thereby, the network station can further be endued with ability of word editing to increase the function of Internet.

The secondary object of the present invention is by the method of uploading and editing words at a network station, the graphic file containing words when in completion of production can be downloaded, printed by the client's terminal, this suits especially those network stations for fabricating advertisements, posters, name cards, books etc., so that the functions of these network stations can be multifunctionalized.

The present invention will be apparent in its technical features after reading the detailed description of the preferred embodiment thereof in reference to the accompanying drawings.

### BRIEF DESCRIPTION OF THE DRAWINGS

FIG. 1 is a flow diagram showing operation and execution of the present invention.

### DETAILED DESCRIPTION OF THE PREFERRED EMBODIMENT

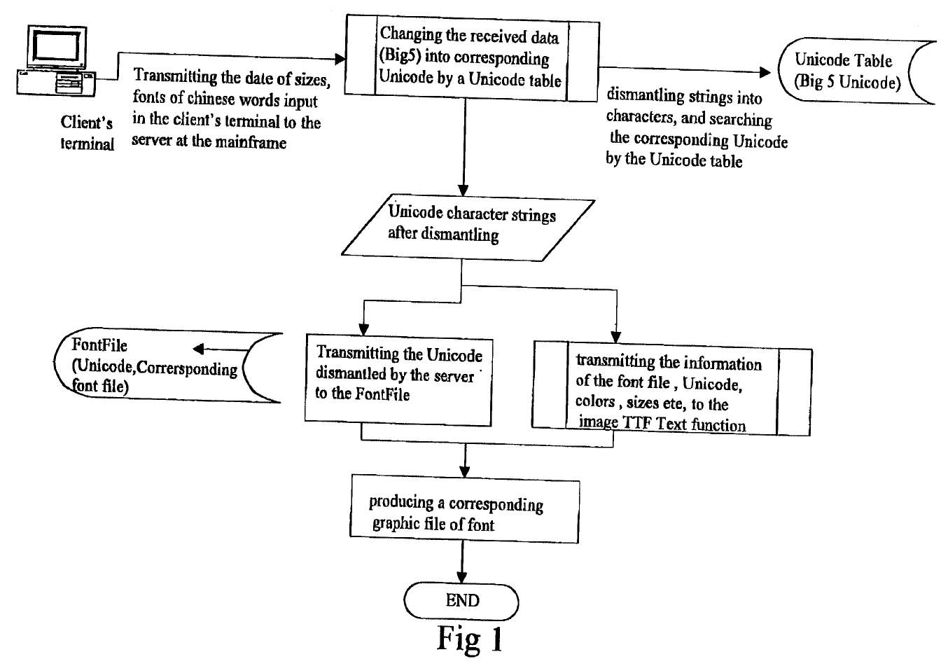

Referring firstly to FIG. 1, the method of uploading and editing words at a network station of the present invention has the following steps in its process flow of operation and execution.

(1) The client terminal connects the server web page at the network mainframe terminal through Internet, and inputs character strings of words (such as Chinese Big5) as well as selects fonts, colors and sizes of words at the “option” on the web page for uploading.

(2) The server at the network mainframe terminal dismantles the data received using a Unicode table into the corresponding information of character digital codes (Unicode) and colors, sizes etc.

(3) The information of character digital codes (Unicode) and colors, sizes etc. dismantled are respectively transmitted to the FontFile and the ImageTTFText program library-of the database for execution.

(4) The server at the network mainframe terminal obtains results of the execution from the FontFile and the ImageTTFText program library, and produces a corresponding graphic file of fonts to be downloaded to the client's terminal.

We can see from the above process flow of operation and execution of the present invention that, in practicing the present invention, the terminal of the mainframe shall include:

The web page design shall include a dialog box for inputting character strings of words, and an entry push button for the options of fonts, colors and sizes of words for operation and editing of a user at the client's terminal.

The program design shall include utilizing a Unicode table to dismantle the uploaded data into various information which is transmitted and placed in a database to find out corresponding fonts and colors, sizes etc. of words to produce a graphic file of fonts and to download to the computer at the client's terminal.

The database shall include a FontFile and a ImageTTFText program library for selection and design of the user at the client's terminal to complete the words to be edited.

By the method of uploading and editing words at a network station stated above of the present invention, a computer at the user's terminal can dynamically input the edited fonts of words to a web page without installing the software of fonts, colors and sizes of words, thereby, the network station can further be endued with the ability of word editing to increase the function of Internet, And the graphic file containing words when in completion of production can be downloaded, printed by the client's terminal, this suits especially those network stations for fabricating advertisements, posters, name cards, books etc., so that the functions of these network stations can be multi-functionalized.

The above process flow of operation and execution of the present invention is only for illustrating a preferred embodiment of the present invention, and not for giving any limitation to the scope of the present invention. It will be apparent to those skilled in this art that various equivalent modifications or changes also fall within the scope of the appended claims.

1. A method of uploading and editing words at a network station, wherein a Unicode table and a font data base are provided in the server of a network mainframe terminal, and an option entry is correspondingly provided on a web page, so that when a client uploads input character strings and selected fonts, colors, sizes etc, of words to said server of said network mainframe terminal, said Unicode table and said font data base dismantle said input into the corresponding information of character digital codes and colors, sizes etc. and send to a FontFile and the ImageTTFText program library of the database for execution and outputting, a corresponding font graphic file thus is produced and downloaded to a computer at a client's terminal to edit fonts on a web page without installing the software of fonts, colors and sizes of words, thereby, the network station is further endued with ability of word editing to increase the function of Internet.

2. The method of uploading and editing words at a network station as in claim 1, wherein
when in completion of production of said graphic file containing words, said file is adapted to being downloaded, printedbysaidclient's terminal, this suits those network stations for fabricating advertisements, posters, name cards, books etc.
